(19) United States
(12) Patent Application Publication
(10) Pub. No.: US 2009/0221732 A1
(43) Pub. Date: Sep. 3, 2009

(54) SURFACE TREATED INORGANIC PARTICLE ADDITIVE FOR INCREASING THE TOUGHNESS OF POLYMERS

(75) Inventor: PATRICK C. WERNETT, UPPER BLACK EDDY, PA (US)

Correspondence Address: DUANE MORRIS LLP - Philadelphia;IP DEPARTMENT, 30 SOUTH 17TH STREET, PHILADELPHIA, PA, 19103-4196, US

(73) Assignee: SPECIALTY MINERALS (MICHGAN), INC., BINGHAM FARMS, MI (US)

(21) Appl. No.: 12/041,113

(22) Filed: Mar. 3, 2008

(51) Int. Cl. C08K 9/10

(52) U.S. Cl. 523/210

(57) ABSTRACT

A mineral additive particles such as calcium carbonate particles coated with one of fatty acids, fatty acid derivatives, rosins, rosinates, polyolefin based waxes, oligomers and mineral oils at a coating level of about 2.3 wt. % or more per weight of the mineral particles when added to a polymer system enhances the toughness of the resulting polymer composite.

### CROSS-REFERENCE TO RELATED APPLICATIONS

This is a U.S. non-provisional application claiming the benefit of U.S. provisional patent application Ser. No. 60/014,240 filed on Dec. 17, 2007, the entire disclosure of which is incorporated herein by reference.

### FIELD OF THE INVENTION

This disclosure is generally related to mineral fillers/additives for polymers.

### BACKGROUND

Among biopolymers, biodegradable or compostable polymers, such as polylactide, poly(ε-caprolactone), polyglyconate, poly(dioxanone) and polyhydroxyalkanoates are finding more and more applications in recent years. Among them, polylactide (PLA) is particularly attractive as a sustainable alternative to petrochemical-derived products. PLA can be synthesized from several forms of lactide stereoisomers, e.g. L-lactide, D-lactide and meso-lactide. PLA also has good optical clarity and high stiffness, but it is also intrinsically brittle and can limit PLA's application in many applications that require better mechanical properties.

### SUMMARY

According to an embodiment of the present disclosure, an additive for polymeric composition is disclosed. An additive for polymeric composition comprises inorganic particles and a coating material coating the inorganic particles at a coating level of about 2.3 wt. % or more, wherein the coating material is one of fatty acids, fatty acid derivatives, rosins, rosinates, polyolefin based waxes, oligomers and mineral oils, and combinations thereof.

According to another embodiment, a resin precursor for a biopolymer comprises a biopolymer resin component and an additive component. The additive component comprises an inorganic particles coated with a coating material coating the inorganic particles at a coating level of about 2.3 wt. % or more, wherein the coating material is one of fatty acids, fatty acid derivatives, rosin, rosinates, oligomers/pre-polymers and mineral oils, and combinations thereof.

According to another embodiment, a biopolymer comprises a base polymer matrix component and an additive component. The additive component comprises an inorganic particles coated with a coating material at a coating level of about 2.3 wt. % or more, wherein the coating material is one of fatty acids, fatty acid derivatives, rosins, rosinates, polyolefin based waxes, oligomers and mineral oils, and combinations thereof.

According to yet another embodiment, a method of enhancing toughness of a biopolymer is disclosed. The method comprises providing a biopolymer in resin form and compounding inorganic additive particles coated with a coating material at a coating level of about 2.3 wt. % or more into the biopolymer resin, wherein the coating material is one of fatty acids, fatty acid derivatives, rosins, rosinates, polyolefin based waxes, oligomers and mineral oils, and combinations thereof.

According to an aspect of the present disclosure, the coating level of the inorganic additive particles are between about 2.3 to 4.0 wt. %. The biopolymer made according to the present disclosure has enhanced toughness that is useful for a variety of applications that were not available to biopolymers because of their low impact resistance.

### BRIEF DESCRIPTION OF THE DRAWINGS

FIG. 1 is a plot of particle size distribution curves of calcium carbonate additive samples used in a first experiment conducted by the inventor.

FIG. 2 is a plot generated from the first experiment conducted by the inventor comparing the room temperature flexural modulus of the various polymer samples measured in the experiment.

FIG. 3 is a plot generated from the inventor's first experiment comparing the room temperature Dynatup multiaxial impact energy measured on the various polymer samples.

FIG. 4 is a plot generated from the inventor's first experiment comparing the Dynatup multiaxial impact energy at zero degrees Celsius measured on the various polymer samples.

FIG. 5 is a plot generated from the inventor's first experiment comparing the room temperature notched Izod impact test results measured on the various polymer samples.

FIG. 6 is a plot generated from the inventor's second experiment showing the room temperature Dynatup drop energy of a PLA polymer filled with 25 wt. % stearic acid coated calcium carbonate as a function of the coating level of the calcium carbonate.

The embodiments of this disclosure are described below with reference to the above drawings.

### DETAILED DESCRIPTION

According to an embodiment of the present disclosure, inorganic additives such as calcium carbonate (CaCO₃) particles coated with a fatty acid greatly improve the mechanical properties of polymers and particularly biopolymers such as biodegradable or compostable polylactide (PLA) polymers without hindering the polymer's compostability. Toughness is a material's ability to absorb energy before fracture and biodegradable polymers such as PLA are brittle because of their inherent low toughness. This property of biopolymers has limited their use but when enhanced with inorganic additives according to the present disclosure, the biopolymers' toughness is substantially improved and enhance the usefulness of biopolymers. The fatty acid coated inorganic additives such as stearic acid coated calcium carbonate can be used for enhancing the toughness or impact resistance of biopolymers such as PLA, poly(ε-caprolactone), polyglyconate, poly(dioxanone), polyhydroxyalkanoates (PHA) and polymeric starches, and combinations thereof.

Biopolymers as referred to herein includes polymers derived from natural renewable resources and/or those that are generally compostable or generally biodegradable polymers. Toughness of biopolymers can be improved by adding an additive comprising inorganic particles that are coated with a coating material such as one of fatty acids, fatty acid derivatives (such as fatty acid amides and fatty acid esters), rosins, rosinates, oligomers, polyolefin based waxes and mineral oils. The inorganic particles are coated with the coating material at a coating level of about 2.3 wt. % or more per weight of the inorganic particles. Biopolymers according to the present invention have improved physical properties (including toughness, ductility, and/or stiffness) and may be incorporated into various products, including automotive and appliance components (e.g., bumpers, dashboards, computer/cell phone housings, etc.), consumer goods (e.g., credit card stock, eating utensils, cups, plateware, etc.), and packaging products (e.g., food containers, bottles, etc.).

The inorganic particles can be one of a carbonate, silica, kaolin, talc, fine metal particles, wollastonite and glass microspheres, and combinations thereof. According to one preferred embodiment, the inorganic particles are calcium carbonate particles coated with a fatty acid such as stearic acid to the coating level of between about 2.3-4.0 wt. % per weight of calcium carbonate. The calcium carbonate can be any type of calcium carbonate such as precipitated calcium carbonate (“PCC”), ground calcium carbonate (“GCC”), and blends thereof.

In one preferred embodiment for enhancing the toughness of PLA polymers, the inorganic additive can be calcium carbonate additive material in particle-like form such as PCC, GCC, or blends thereof. Some examples of calcium carbonate additives in which the present disclosure can be implemented are UFT product available from OMYA Inc. North America, and Superfil® product available from Specialty Minerals Inc. The calcium carbonate particles can be coated with a fatty acid such as stearic acid. Stearic acid is one of the useful types of saturated fatty acids that comes from many animal and vegetable fats and oils. Stearic acid has a chemical formula CH₃(CH₂)₁₆COOH.

The enhanced polymers described above can be prepared by compounding the coated calcium carbonate particles into the polymer resin precursor for the biopolymer and forming the composite material into a desired form. The coated calcium carbonate particles can be compounded into the polymer resin precursor by melt compounding using a twin screw extruder or similar equipment. An example of such an extruder is a twin screw extruder manufactured by the Leistritz Corporation. As an additive to enhance the toughness of a PLA polymer, the calcium carbonate particles coated with about 2.3 wt. % up to about 4.0 wt. % of stearic acid can be compounded into PLA at a loading level between 15 to 30 wt. % per weight of PLA polymer.

The fatty acid coated inorganic particles described herein are also useful for enhancing the mechanical properties of other polymers such as polyethylene terephthalate (PET) and PET derivatives and co-polymers.

Coating the mineral particles according to the method of the present disclosure has resulted in unexpectedly significant increase in the toughness of the polymer system. It is generally known that surface treatment of mineral filler particles in polymer systems improve mechanical properties of the polymer somewhat by reducing absorbed moisture on the particles and lowering the surface energy of the mineral particles. This results in better dispersion of the mineral particles in the polymer system. But, with previously known surface treatments to the mineral filler particles, only minor increase in toughness of the polymer systems were observed.

With the coating of the mineral particles according to the present disclosure, substantial enhancement of the polymer composite's toughness is achieved. This appears to be attributed to the coated mineral particles in the resulting polymer composite matrix absorbing energy through debonding at the particle-to-polymer interface more efficiently than in conventional surface treated mineral fillers. The debonding at the particle-to-polymer interface absorbs energy of a crack propagating through the polymer composite.

### EXAMPLE 1

In a laboratory experiment, the inventor was able to demonstrate the beneficial effect of a fatty acid coated calcium carbonate additive in improving the toughness of PLA polymer. Specifically, the improvement in low temperature impact toughness as well as improvement in the stiffness of PLA was demonstrated.

The properties of PLA polymer can be controlled by controlling the ratio of the stereoisomers comprising the PLA. For example, the polymerization of predominately the L-form with greater than about 15 mole % of either the D or meso lactide will generate an amorphous PLA random copolymer. Whereas, the polymerization of the L-form of lactic acid will lead to poly-L-lactide (PLLA) which is a semicrystalline polymer with the crystallinity of up to 40% or more.

The inventor used a number of different calcium carbonate based additives and coated them with stearic acid and compounded into PLLA polymer samples to confirm the beneficial effects of stearic acid coated calcium carbonate on the mechanical properties of PLA. The particular calcium carbonate additive samples utilized as the starting materials were Specialty Minerals Inc.'s EMforce® Bio, Superfil®, OMYA's UFT, and a 50:50 blend of EMforce® Bio and Superfil®. Specialty Minerals Inc.'s EMforce® Bio is an engineered calcium carbonate filler additive that is coated with greater than 2.7 wt. % of stearic acid as-manufactured and is intended for reinforcing biopolymers. The samples of the other calcium carbonate additives were dry coated using a laboratory Henschel mixer to each coating level concentration (0.0 to 4.0 wt. %). Each calcium carbonate additive material was compounded into PLLA resin at a target concentration of about 25 wt. % level.

The compounding of calcium carbonate additive into PLLA can be carried out by melt compounding using a twin screw extruder. In this example, a Leistritz twin screw extruder was used having an L/D ratio of 40, a diameter of 27 mm and 10 independent heating zones was used to compound all formulations. The extruder was operated in a co-rotating mode to ensure good dispersion of calcium carbonate in the PLLA. The PLLA resin was introduced into the feed throat of the extruder (at ambient temperature) using a K-TRON hopper-fed loss on weight feeder. All fillers were side-fed via a K-TRON loss-on-weight feeder into zone 5 of the extruder.

The EMforce® Bio material was produced at a Specialty Minerals Inc.'s manufacturing facility and has an as-manufactured stearic coating level of 3.3 wt. %. The other calcium carbonate additive samples were prepared in the laboratory to a total coating level of 3.3 wt. %. EMforce® Bio produced the greatest impact/stiffness balance compared to the other fillers but at the 3.3 wt. % coating level, all of the fillers increase the PLLA toughness similarly (including the OMYA UFT product). A 50:50 blend of EMforce® Bio and Superfil® produced properties that were intermediate between the two pure components and is a viable option as a “next generation” EMforce Bio product as a potential reduced cost product. The addition of 3.3 wt. % stearic acid to the PLLA resin without a calcium carbonate additive showed no improvement in the mechanical properties compared to the unfilled resin.

The calcium carbonate additives were melt compounded in PLLA (Natureworks 4042D) on a Leistritz 27-mm twin screw extruder operating in co-rotating mode at target concentrations of 20, 25 and 30 wt. %. 3.3 wt. % stearic acid was also compounded with PLLA to determine if the stearic acid alone could improve PLLA toughness. Composite samples were dusted with an aluminum stearate antiblocking agent prior to injection molding on an Argburg 88-ton Allrounder machine. Test specimens were conditioned in a controlled temperature and humidity environment (23° C. and 50% R.H.) for 3 days prior to mechanical testing.

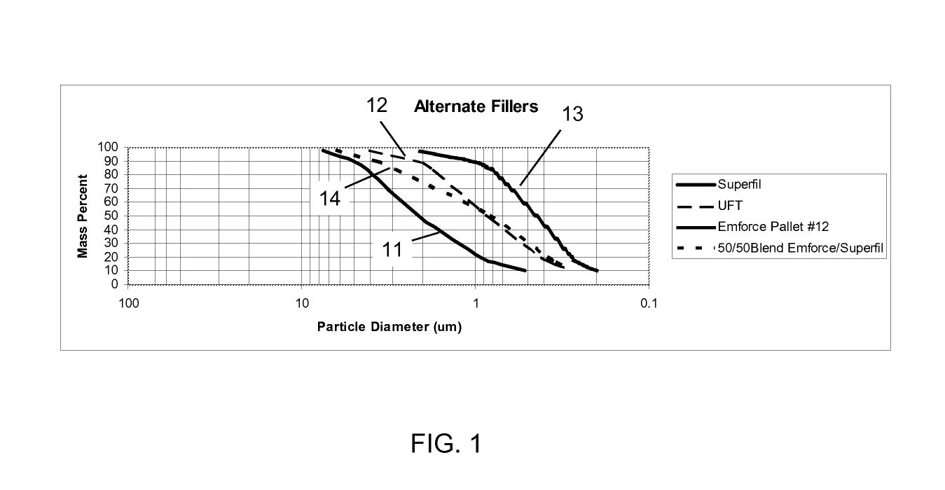

The particle size distribution of the calcium carbonates used in this study is presented in Table 1 and the plot shown in FIG. 1. Samples plotted are Superfil® calcium carbonate coated with stearic acid to 3.3 wt. % level 11; UFT calcium carbonate coated with stearic acid to 3.3 wt. % level 12; EMforce® Bio (Pallet #12) having as-manufactured 3.3 wt. % stearic acid coating level 13; and a 50/50 blend of EMforce® Bio/Superfil® 14. The Superfil® 11 had the largest topsize and median particle size while EMforce® Bio 13 had the lowest topsize and median particle size.

TABLE 1
Particle Size Distribution of the Calcium Carbonate Additives (μm).

| Cumulative Mass | | | Emforce ® | 50/50 Blend |
|---|---|---|---|---|
| Finer % | Superfil | UFT | Pallet #12 | Emforce ®/Superfil |
| 98 | 7.596 | 4.118 | 2.078 | 6.399 |
| 90 | 4.957 | 2.150 | 0.997 | 3.777 |
| 84 | 4.209 | 1.770 | 0.809 | 2.930 |
| 50 | 2.110 | 0.867 | 0.447 | 0.826 |
| 20 | 0.933 | 0.424 | 0.280 | 0.388 |
| 16 | 0.776 | 0.370 | 0.253 | 0.345 |
| 10 | 0.521 | 0.28 | 0.199 | 0.273 |

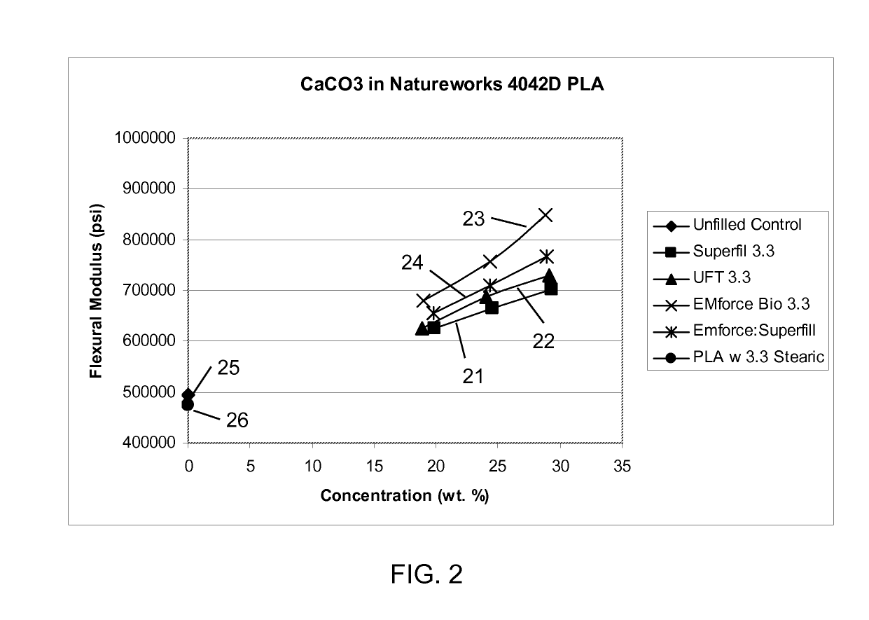

FIG. 2 shows the flexural modulus of the various polymer samples measured at 23° C. (room temperature). As discussed above PLLA resin samples were compounded with calcium carbonate to target concentrations of 20, 25 and 30 wt. %. The respective line plots shown are PLLA filled with Superfil® (3.3 wt. % coating level) 21; PLLA filled with UFT (3.3 wt. % coating level) 22; PLLA filled with EMforce® Bio (3.3 wt. % coating level) 23; PLLA filled with 50/50 EMforce® Bio/Superfil® blend (3.3 wt. % coating level) 24. In addition, control samples of an unfilled PLLA control 25 and PLLA with just 3.3 wt. % (based on total weight of the polymer composite) of stearic acid 26 were also prepared and measured. Because the two control samples are not filled with calcium carbonate their additive concentration levels are 0.0 wt. %. All calcium carbonate additives significantly increased the flexural modulus compared to the unfilled PLLA 25 and stearic acid—PLLA resin mix 26. EMforce® Bio filled PLLA 23 produced the greatest increase in flexural modulus. Superfil® filled PLLA 21 produced the lowest increase in flexural modulus of all the calcium carbonate containing composites and the 50/50 EMforce® Bio/Superfil® blend 24 yielded intermediate results as expected.

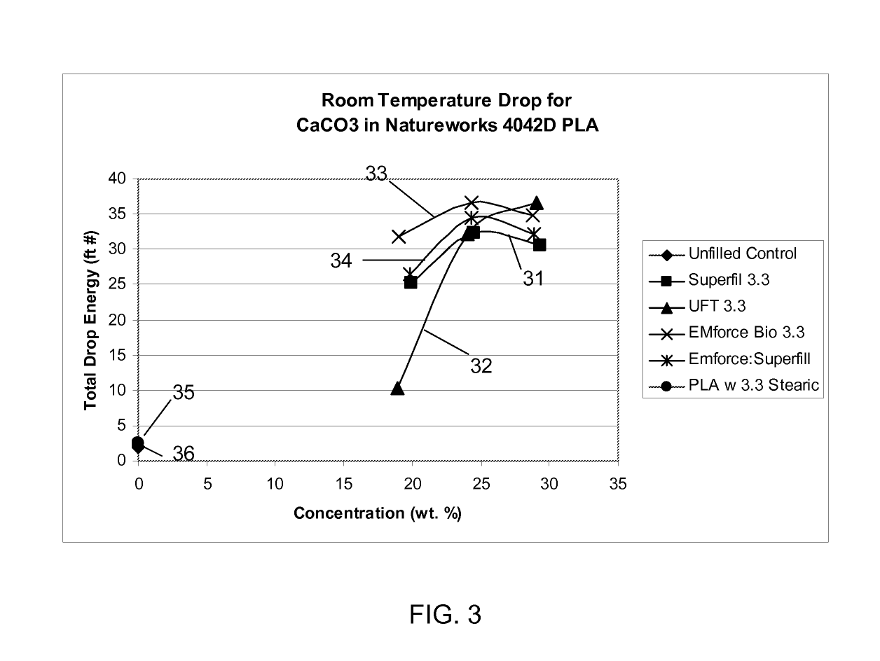

FIG. 3 shows the results of the Dynatup multi-axial impact energies at 23° C. (room temperature). The EMforce® Bio filled PLLA composite 33 produced the greatest room temperature toughness compared to the other calcium carbonate filled PLLA composites 31 and 34 with the exception of the UFT filled PLLA 32 at 30 wt. % loading which had a comparable toughness. Previous studies have shown that a minimum of 20 wt. % EMforce® Bio is required to substantially increase the PLLA composite toughness compared to the unfilled control PLLA 35. A maximum toughness is achieved around 25 wt. % loading of EMforce® Bio and the toughness begins to decrease above 30 wt.%. This is the same trend observed for the Superfil® filled PLLA 31 and the EMforce® Bio/Superfil® blend 34.

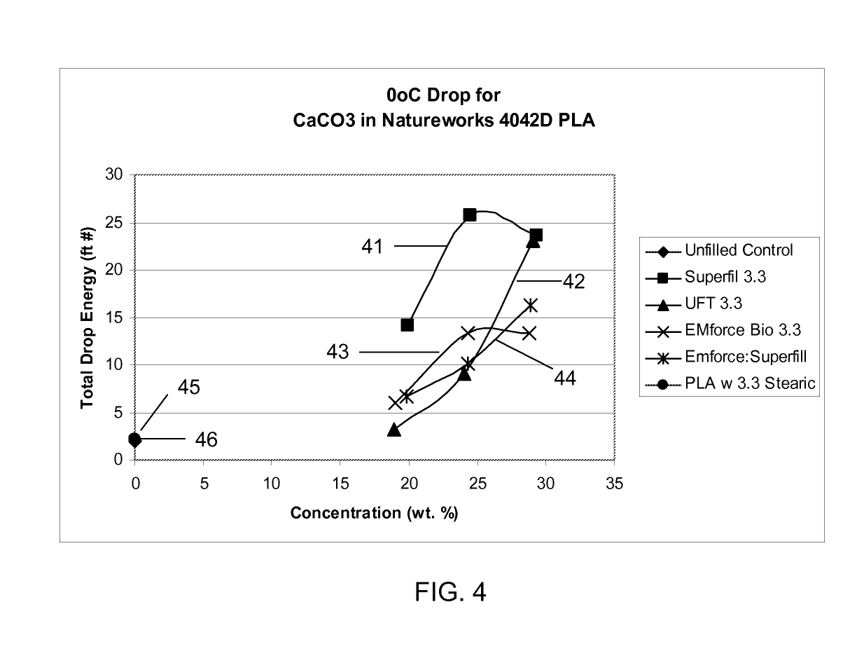

FIG. 4 shows the results of the Dynatup multi-axial impact energies at 0° C. All of the PLLA composites failed in a brittle mode (or nearly all brittle failures, see Table 2). In this case, the Superfil® filled PLLA 41 produced the greatest toughness to which the UFT filled PLLA 42 matched at the 30 wt. % concentration. This is likely due to a surface area-coating level effect, Superfil® having the lowest surface area. The lower surface area of Superfil® product would require less stearic acid molecules to encapsulate the particle compared to the higher surface area particles. This would be expected to produce a thicker coating level around the Superfil® particles. Previous studies in Natureworks 4032D PLLA indicated that EMforce® Bio can greatly increase 0° C. impact energy of PLLA and provide a ductile failure mechanism at coating level concentrations of about 3.5 wt. % or greater.

Table 2 also includes the heat deflection temperature (“HDT”) data. All of the mineral fillers at every concentration examined in this study had no effect on increasing the HDT of the PLLA. The addition of stearic acid in the absence of a mineral filler showed a significant decrease in the HDT of the PLLA.

TABLE 2
Multi-Axial Impact Failure Mechanisms and the Heat
Deflection Temperature of PLA and PLA Composites

| | Mineral | % Ductility | | Heat Deflection |
|---|---|---|---|---|
| Sample | Concentration (%) | 23° C. | 0° C. | Temperature (° C.) |
| PLA Control | 0 | 0 | 0 | 54.2 |
| Superfil ® | 20 | 50 | 10 | 54.2 |
| | 25 | 90 | 10 | 53.9 |
| | 30 | 100 | 10 | 54.2 |
| UFT | 20 | 0 | 0 | 54.1 |
| | 25 | 80 | 0 | 53.9 |
| | 30 | 100 | 10 | 54.1 |
| EMforce ® | 20 | 100 | 0 | 54.3 |
| Bio | 25 | 100 | 0 | 54.2 |
| | 30 | 100 | 0 | 53.7 |
| EMforce ® | 20 | 50 | 0 | 53.6 |
| Bio | | | | |
| Superfil ® | 25 | 100 | 0 | 53.6 |
| Blend | 30 | 90 | 10 | 53.7 |
| (50:50) | | | | |
| PLA + 3.3% | 0 | 0 | 0 | 49.7 |
| Stearic | | | | |

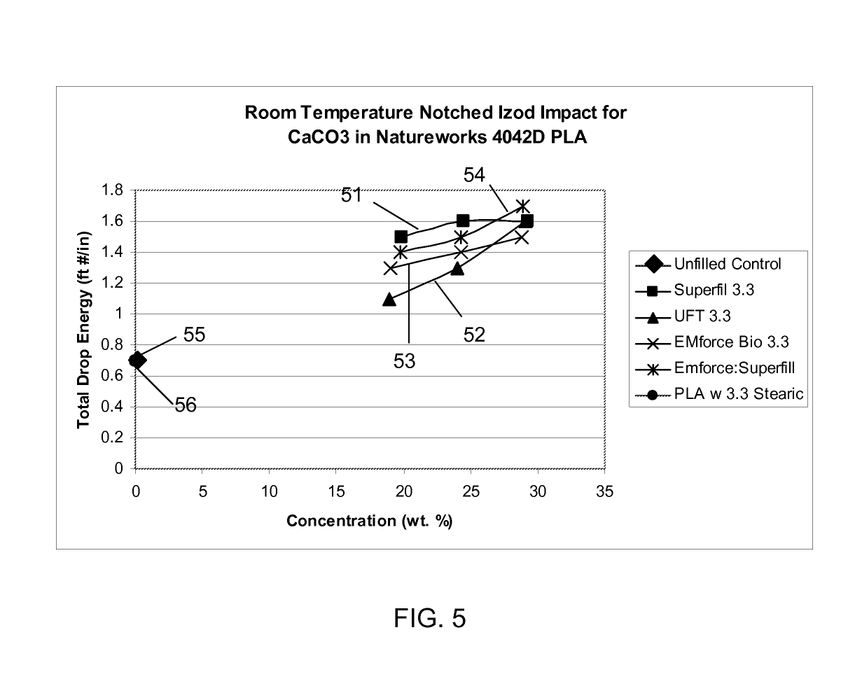

FIG. 5 shows the room temperature notched Izod impact test results performed on the polymer samples. All of the stearic-coated calcium carbonate filled PLLA composites were slightly better than the unfilled and stearic acid—PLLA controls and similar to one another. The plot lines shown are Superfil® filled PLLA 51, UFT filled PLLA 52, EMforce® Bio filled PLLA 53, 50/50 EMforce® Bio/Superfil® blend filled PLLA 54, unfilled PLLA control 55 and PLLA with stearic acid control 56.

The experiment discussed above show that at 3.3 wt. % stearic coating level, no further improvement on the mechanical properties of the PLLA, such as the impact toughness, is observed over the performance achieved with 2.7 wt. % stearic acid coating level.

### EXAMPLE 2

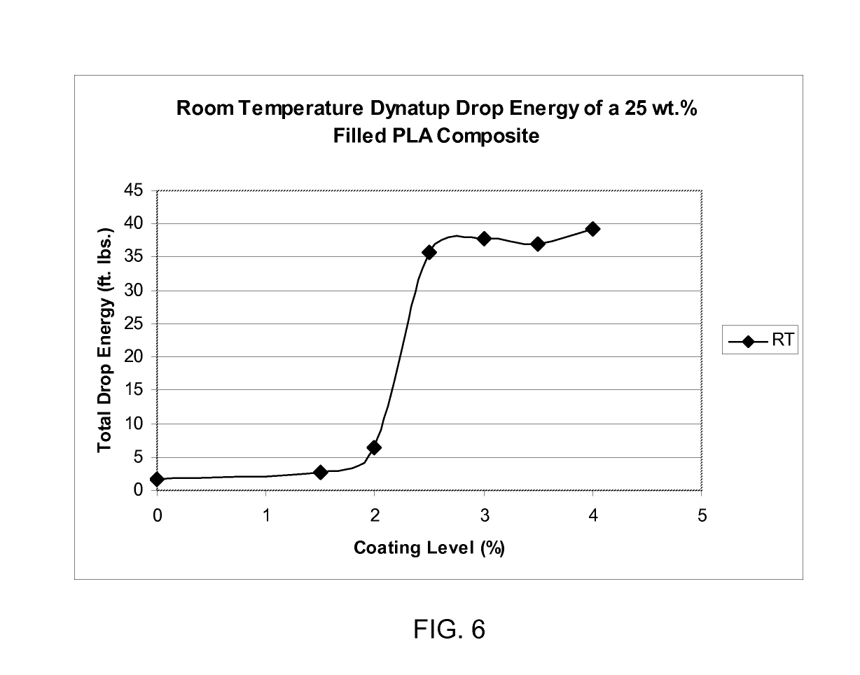

FIG. 6 shows the results of a stearic acid coating level study on an uncoated EMforce® Bio calcium carbonate precursor particle to determine the optimal coating level. Falling weight impact energy was measured for PLA polymer samples prepared from polymer resin compounded with calcium carbonate particles coated with stearic acid at various coating levels. The calcium carbonate precursor samples were dry-coated using a laboratory Henschel mixer to each coating level concentration (0.0 to 4.0 weight %). However, the coating process is not limited to a dry-coating process. A wet-coating process can also be used. Each calcium carbonate material was compounded into PLLA at a target concentration of 25 wt. %. The measurement of toughness in this test is a falling weight. The resulting plot of FIG. 6 shows a classic “S-shaped” curve 60 demonstrating a minimum stearic acid coating level required to improve impact toughness of the PLLA. From the steep part 62 of the “S-curve,” a minimum coating of about 2.3 wt. % is estimated to be required to greatly improve the impact toughness of a PLLA composite to about 25 ft. lbs. or better. Tables 3A-3C show the underlying data for the plot of FIG. 6.

TABLE 3A
Project #2007-5 EMforce coating level study in PLA 4032D

| | | | | NatureWorks | | |
|---|---|---|---|---|---|---|
| | | | | PLA | Flexural Modulus | |
| | | Coating level | Filler | 4032D | ASTM-D790 | |
| Sample ID | Filler type | % stearic acid | Level (%) | (%) | (PSI) | S.D.+/− |
| 4962-194-1 | None | None | 0 | 100 | 498,979 | 5,784 |
| 4962-194-8 | EMforce (produced 3/07) | 0.0 | 25 | 75 | 813,764 | 1,537 |
| 4962-194-2 | EMforce (produced 3/07) | 1.5 | 25 | 75 | 763,734 | 8,973 |
| 4962-194-3 | EMforce (produced 3/07) | 2.0 | 25 | 75 | 754,623 | 1,313 |
| 4962-194-4 | EMforce (produced 3/07) | 2.5 | 25 | 75 | 740,978 | 2,890 |
| 4962-194-5 | EMforce (produced 3/07) | 3.0 | 25 | 75 | 757,026 | 5,261 |
| 4962-194-6 | EMforce (produced 3/07) | 3.5 | 25 | 75 | 766,653 | 5,411 |
| 4962-194-7 | EMforce (produced 3/07) | 4.0 | 25 | 75 | 743,614 | 4,367 |

TABLE 3B
Project#2007-5 EMforce coating level study in PLA 4032D (Continued)

| | DYNATUP IMPACT (drop ht. = 8.0 in.) | | | | | | |
|---|---|---|---|---|---|---|---|
| | 23° C. | | | | | | 0° C. |
| | Initiation | | Initiation E | | Total E | Total E STD | Total E STD |
| Sample ID | (ft.lbs) | % D | STD. | DI | (ft.lbs) | (ft.lbs) | (ft.lbs) |
| 4962-194-1 | 1.8 | 0 | 0.7 | 11.7 | 2.1 | 0.7 | 0.7 |
| 4962-194-8 | 1.4 | 0 | 0.4 | 17.7 | 1.7 | 0.5 | 0.5 |
| 4962-194-2 | 2.2 | 0 | 1.2 | 15.1 | 2.7 | 1.4 | 0.5 |
| 4962-194-3 | 5.5 | 0 | 2.6 | 10.4 | 6.3 | 3.5 | 0.6 |
| 4962-194-4 | 16.7 | 100 | 0.8 | 53.2 | 35.7 | 2.6 | 2.5 |
| 4962-194-5 | 17.5 | 100 | 0.6 | 53.7 | 37.7 | 1.1 | 3.4 |
| 4962-194-6 | 17.1 | 100 | 0.3 | 53.7 | 37.0 | 1.0 | 4.5 |
| 4962-194-7 | 17.8 | 100 | 0.8 | 54.6 | 39.2 | 0.9 | 2.7 |

TABLE 3C
Project#2007-5 EMforce coating level study in PLA 4032D (Continued)

| | Notched Izod | | Tensile Strength | | | |
|---|---|---|---|---|---|---|
| | impact @RT | | ASTM-D6381(2 IN./MIN.) | | | |
| | ASTM-D256 | | Strain @ | Stress @ peak | | rain @ bre |
| Sample ID | (ft. lbs/in.) | S.D. | peak (%) | (PSI) | S.D. | (%) |
| 4962-194-1 | 0.72 | 0.08 | 2.7 | 11,171 | 75 | 2.9 |
| 4962-194-8 | 0.52 | 0.08 | 1.5 | 9,865 | 347 | 1.5 |
| 4962-194-2 | 0.79 | 0.11 | 1.6 | 9,161 | 332 | 1.9 |
| 4962-194-3 | 1.09 | 0.14 | 2 | 8,579 | 80.0 | 2.1 |
| 4962-194-4 | 1.58 | 0.13 | 2.2 | 8,325 | 102.0 | 2.4 |
| 4962-194-5 | 1.96 | 0.08 | 2.2 | 8,124 | 23.0 | 2.4 |
| 4962-194-6 | 2.25 | 0.16 | 2.1 | 7,941 | 89 | 2.3 |
| 4962-194-7 | 3.25 | 0.15 | 2 | 7,855 | 45.2 | 2.2 |

Note:
All samples were evaluated unannealed in 5 lb batches.

According to the above data, at room temperature, the brittle-ductile transition occurs above 2.0 wt. % stearic coating level. The falling weight failures remain ductile at all values above 2.5 wt. % and the beneficial effect appears to flatten out somewhat above 3.0 wt. % in room temperature applications. This transition point will most likely change if the test conditions are changed. Thus at least for room temperature applications, in PLA polymer systems, the stearic coating level can be controlled to between about 2.3-4.0 wt. % to minimize the amount of stearic acid. As shown in the curve of FIG. 6, the Dynatup drop energy has just begun to improve above 2.0 wt. % stearic coating level, in another preferred embodiment, the stearic coating level can be controlled to between about 2.5-4.0 wt. %. A higher impact velocity, or lower temperature, should require a higher coating level to produce a ductile failure. It appears that a coating level greater than 3.5 wt. % coating is required to produce ductility at a test temperature of zero degrees centigrade.

The notched Izod impact strength increased linearly with coating level. Flexural modulus was not affected by coating level while tensile modulus decreased as coating level increased. This is because the coating decreases the bond strength between the filler and the polymer. It is easier for the filler particles to “pull out” of the polymer when a tensile stress is applied. Note that the tensile strength also decreases with an increase in coating level. The “pull out” forces are lower in flexural testing and therefore the flexural modulus is not affected.

It appears that a coating level of about 3.0-4.0 wt. % would be a preferred stearic acid coating range to ensure improvement in the impact toughness of the PLLA resin. The impact toughness balance improves with an increase in coating level but there is a trade-off with tensile strength and tensile modulus.

By using the stearic coated calcium carbonate filler of the present disclosure, the toughness of the PLA resin can be improved by as much as 10× that of the unfilled resin. Stearic acid as the coating material for the calcium carbonate filler is an example only and other fatty acid coatings would be expected to provide similar improvement in the resin's toughness.

Based on the essential features of the embodiments of the method disclosed herein, further variations will now become apparent to persons skilled in the art. All such variations are considered to be within the scope of the appended claims. In addition, where features or aspects of the invention are described in terms of Markush groups, those skilled in the art will recognize that the invention is also thereby described in terms of any individual member or subgroup of members of the Markush group.

What is claimed is:

1. An additive for polymeric composition comprising:
inorganic particles; and a coating material coating the inorganic particles at a coating level of about 2.3 wt. % or more, wherein the coating material is one of fatty acids, fatty acid derivatives, rosins, rosinates, polyolefin based waxes, oligomers and mineral oils, and combinations thereof.

2. The additive of claim 1, wherein the coating material is stearic acid.

3. The additive of claim 1, wherein the inorganic particles are calcium carbonate particles.

4. The additive of claim 3, wherein the calcium carbonate particles are selected from the group consisting of precipitated calcium carbonate, ground calcium carbonate, and blends thereof.

5. The additive of claim 1, wherein the inorganic particles comprise one of a carbonate, silica, kaolin, talc, wollastonite, fine metal particles and glass microspheres, and combinations thereof.

6. The additive of claim 1, wherein the coating level is between about 2.3 to 4.0 wt. %.

7. A resin precursor for a biopolymer comprising:
a biopolymer resin component; and an additive component comprising an inorganic particles coated with a coating material coating the inorganic particles at a coating level of about 2.3 wt. % or more, wherein the coating material is one of fatty acids, fatty acid derivatives, rosins, rosinates, polyolefin based waxes, oligomers and mineral oils, and combinations thereof.

8. The resin precursor of claim 7, wherein the coating material is stearic acid.

9. The resin precursor of claim 7, wherein the inorganic particles are calcium carbonate particles.

10. The resin precursor of claim 9, wherein the calcium carbonate particles are selected from the group consisting of precipitated calcium carbonate, ground calcium carbonate, and blends thereof.

11. The resin precursor of claim 7, wherein the inorganic particles comprise one of a carbonate, silica, kaolin, talc, wollastonite, fine metal particles and glass microspheres, and combinations thereof.

12. The resin precursor of claim 7, wherein the coating level is between about 2.3 to 4.0 wt. %.

13. The resin material of claim 7, wherein the polymer resin component is a polylactide polymer resin.

14. The resin material of claim 7, wherein the polymer resin component is one of biopolymers such as polylactide (PLA), poly(ε-caprolactone), polyglyconate, poly(dioxanone), polyhydroxyalkanoates (PHA) and polymeric starch polymer resins, and combinations thereof.

15. A biopolymer comprising:
a base polymer matrix component; and an additive component comprising an inorganic particles coated with a coating material at a coating level of about 2.3 wt. % or more, wherein the coating material is one of fatty acids, fatty acid derivatives, rosins, rosinates, polyolefin based waxes, oligomers and mineral oils, and combinations thereof.

16. The biopolymer of claim 15, wherein the coating material is stearic acid.

17. The biopolymer of claim 15, wherein the inorganic particles are calcium carbonate particles.

18. The biopolymer of claim 17, wherein the calcium carbonate particles are selected from the group consisting of precipitated calcium carbonate, ground calcium carbonate, and blends thereof.

19. The biopolymer of claim 15, wherein the inorganic particles comprise one of a carbonate, silica, kaolin, talc, wollastonite, fine metal particles and glass microspheres, and combinations thereof.

20. The biopolymer of claim 15, wherein the coating level is between about 2.3 to 4.0 wt. %.

21. The biopolymer of claim 15, wherein the polymer resin component is a polylactide polymer resin.

22. The biopolymer of claim 15, wherein the polymer resin component is one of biopolymers such as polylactide (PLA), poly(ε-caprolactone), polyglyconate, poly(dioxanone), polyhydroxyalkanoates (PHA) and polymeric starch polymer resins, and combinations thereof.

23. Automotive components comprising the biopolymer of claim 15.

24. Appliance components comprising the biopolymer of claim 15.

25. Consumer goods comprising the biopolymer of claim 15.

26. Packaging products comprising the biopolymer of claim 15.

27. A method of enhancing toughness of a biopolymer comprising:
providing a biopolymer in resin form; and
compounding inorganic additive particles coated with a coating material at a coating level of about 2.3 wt. % or more into the biopolymer resin, wherein the coating material is one of fatty acids, fatty acid derivatives, rosins, rosinates, polyolefin based waxes, oligomers and mineral oils, and combinations thereof.

28. The method of claim 27, wherein the inorganic additive particles are calcium carbonate particles.

29. The method of claim 28, wherein the calcium carbonate particles are selected from the group consisting of precipitated calcium carbonate, ground calcium carbonate, and blends thereof.

30. The method of claim 27, wherein the inorganic particles comprise one of a carbonate, silica, kaolin, talc, wollastonite, fine metal particles and glass microspheres, and combinations thereof.

31. The method of claim 27, wherein the coating material is stearic acid.

32. The method of claim 27, wherein the coating level is between about 2.3 to 4.0 wt. %.
